(19) United States
(12) Patent Application Publication
(10) Pub. No.: US 2002/0103681 A1
(43) Pub. Date: Aug. 1, 2002

(54) Reservation system

(76) Inventors: Athanassios Tolis, London (GB); Diomidis Spinellis, Kifisia (GR); Philip Porter, London (GB); Elias Papavassilopoulos, London (GB)

Correspondence Address: TESTA, HURWITZ & THIBEAULT, LLP, HIGH STREET TOWER, 125 HIGH STREET, BOSTON, MA, 02110, US

(21) Appl. No.: 09/773,257

(22) Filed: Jan. 31, 2001

(51) Int. Cl. G06F 17/60

(52) U.S. Cl. 705/5

(57) ABSTRACT

There is disclosed a system for making reservations, in which the system includes a central on-line reservation provider through which reservations for one or more individual service providers may be made, one or more individual service providers through which reservations for the respective individual service providers may be made directly, and means for communicating between the central reservation provider and the respective individual service providers, wherein a first portion of the available reservations from each individual service provider are held by the central reservation provider and a second portion of the available reservations from each individual service provider are held by each respective individual service provider and, if a reservation requested from either the central reservation provider or an individual service provider is not available from that provider, available reservations are transferred from the other of the central reservation provider or the individual service provider to the central reservation provider or the individual service provider via the means for communicating so as to allow a reservation to be made.

### FIELD OF THE INVENTION

The present invention relates to a system for making time and/or location specific reservations such as for example, reserving a table in a restaurant or a room in a hotel.

### BACKGROUND OF THE INVENTION

Reservations are sometimes made directly through a service provider, for example by telephoning a restaurant or theatre box office. However, it is often more convenient for customers to make reservations through a centralised booking agency which can provide information about a whole range of alternative services or products available. In particular, centralised Internet booking agencies have become increasingly popular as an easy, efficient way of making reservations. To ensure that a particular product or service does not get overbooked however, a system must be provided by which the same space cannot be reserved more than once.

In some computerised booking systems, a permanent link is established between the service provider which maintains a central database of available reservations and any booking agencies offering reservations through that service provider. Thus, all reservations made by the booking agencies are made through the same central database which is simultaneously updated as reservations are made and so there is no risk of the service being over booked. However, such systems have the disadvantage that they are expensive to run and can only be installed on “always on” networks. In particular, in cases where a very large number of service providers such as individual restaurants are connected to a central Internet reservation provider or booking agency, the reliability of maintaining a permanent on-line connection between the central Internet reservation provider and each of the service providers' databases can be low.

### SUMMARY OF THE INVENTION

From a first aspect, the present invention provides a system for making customer reservations, the system comprising: at least one individual service provider through which reservations for the respective individual service providers may be made directly; a central reservation provider through which reservations for the at least one individual service provider may be made; and means for communicating between the central reservation provider and the respective individual service providers, wherein a first portion of the available reservations from each individual service provider are held by the central reservation provider and a second portion of the available reservations from each individual service provider are held by each respective individual service provider and, if a reservation requested from either the central reservation provider or an individual service provider is not available from that provider, available reservations are transferred from the other of the central reservation provider or the individual service provider to the central reservation provider or the individual service provider via the means for communicating so as to allow a reservation to be made.

With the system described above, communication need only be established between the reservation and service providers if a reservation requested from a reservation provider is not available from that provider. This has the advantage that there is no need for permanent communication between the providers. Further, as the providers each hold only some of the available reservations, there is no danger of spaces being double booked.

The central reservation provider could for example be a database operated through a call centre. In a preferred embodiment however, the central reservation provider is an Internet booking service.

Preferably, the individual service provider uses computer software for communicating automatically with the Internet booking service. Thus, the client interface of a booking service according to the invention need not be any more complex than that of a traditional Internet booking system using a permanent on-line connection with other reservation providers. Further, as a permanent connection between the reservation and service providers is not needed, the reservation system can be installed over a local area network.

Preferably, the system comprises means for automatically activating the means for communicating between the central reservation provider and individual service providers at regular intervals to transfer available reservations between the providers if the distribution of the available reservations between the providers is out of balance. This allows the reservation service provider to ensure that reservations are available from both the central reservation provider and the individual service provider until the majority of the reservations have been taken. It will be understood that the system could be programmed to distribute the available reservations between the providers in any desired ratio.

The invention described above is relevant to any booking system including systems handling only reservations for services for which a predetermined number of reservations for a predefined time are available (e.g. theatre or concert tickets). In some situations however, reservations may be made for one or more people at any chosen time such that the times of different reservations made may overlap (i.e. the reservations are time specific). One example of this is the restaurant business. The customer making the reservation may also be given the option of specifying which table they wish to sit at and in this case the reservation is also location specific. The same applies for example to hotel room bookings where the customer specifies the number of nights for which they wish to stay and also whether they want a particular room.

Traditionally, tables in restaurants have been booked directly through the restaurant. A customer specifies the number of people and the time that they wish to eat at and the restaurant then reserves a particular table of the appropriate size for a time slot of for example two hours beginning at the time specified by the customer. The restaurant staff then know not to allow any further bookings for that table until after the end of the reservation time slot.

The inventors have realized however that there is no need to specify the table at which customers will be sitting unless they specifically request a particular table. Thus, the inventors have realised that in the example of a restaurant, the availability of each table over a dinner session may be split into consecutive blocks or time slots of a predetermined duration and that any blocks for tables of the same size which have the same start time are interchangeable. This property of the blocks is defined as “fungibility”. For example therefore, if a restaurant contains five tables for two people, the table availability will be represented as five sets of consecutive blocks of predetermined duration and, as long as at least one of the five blocks is available at each consecutive start time over the period for which a customer makes a reservation, it will always be possible to seat customers at the same table for the duration of their meal.

From a second aspect therefore, the present invention provides a reservation system for reserving an item from a plurality of similar items in which the availability of each item is divided into consecutive blocks of a predetermined duration covering the period for which the item is available so as to provide a plurality of sets of said consecutive blocks, and the system accepts a reservation request if at least one consecutive block representing any of the items is available for each consecutive part of the time period for which the reservation is required.

The system described has the advantage that a greater number of reservations can potentially be fitted into the available space than in the case where reservations are made for a particular table such that the reservations made for that table must not overlap. This is because unreserved blocks of time for one item can potentially be combined with unreserved blocks of time for another item to allow further reservations to be made. It has the additional advantage that the fungible blocks representing available reservations may be transferred between two or more reservation providers without any risk of overbooking occurring. It will be appreciated that the invention described above would be equally applicable to other types of time specific reservations such as for example, the reservation of hotel rooms for one or more nights.

In practice in restaurants there may be many different available table sizes such as for example, tables for 2, 3, 4, 5 or 6 people. In this case, it is important to distinguish between table sizes when making reservations and so the blocks may be tagged to indicate the type of item to which they refer. Thus, in the case of restaurant reservations, the blocks could be tagged to indicate the size of table whereas in hotel reservations the blocks could for example be tagged to indicate whether they related to single or double rooms.

In the case where several different types of item were available to be reserved therefore, the blocks would preferably be tagged to indicate the type of item to which they related and a reservation would only be made if at least one consecutive block relating to the type of item required was available for each consecutive part of the time period for which the reservation was required.

The duration of the blocks could be any suitable time period depending on the context in which the reservation system is used. In restaurant reservations for example where the average length of a seating is about two hours, the blocks are preferably of 15 minute duration. Thus a standard table reservation would cover eight consecutive blocks of 15 minutes. In the context of hotel reservations in contrast, each block could be 24 hours long.

Preferably, the reservation system according to the second aspect of the invention is used to provide a reservation database. This database could include the total number of blocks available and in this case the blocks would be marked as reserved within the database once a reservation covering those blocks had been made. Alternatively, the database could just store details of any reservations already made, together with data giving the numbers and types of items available for reservation. The reservation system would then calculate the number of available blocks for reservation from the stored data each time that a reservation was requested and, if the reservation was made, it would then be added to the data stored in the database.

It is desirable in situations such as restaurant reservations for customers to be able to specify a particular table at which they with to sit. Similarly, it is preferable to be able to combine two or more tables of a certain size in order to accommodate a large party at a single table. These types of situation are referred to for the purposes of this application as location specific reservations. The inventors have realised that where only a single location specific reservation is made for any particular type of item, the remaining blocks within the reservation system can still be combined in any desired combination without risking over booking (i.e. the remaining blocks are still fungible). However, if two or more location specific reservations are made for the same type of item, the remaining blocks of time within the reservation system cease to be entirely fungible. This means that combining consecutive blocks across items to form a reservation in this instance could lead to overbooking of the restaurant. This problem is referred to as the packing problem.

In order to avoid overbooking due to the packing problem, the reservation system of the invention preferably includes means for handling a fixed location reservation such that when a fixed location reservation is requested, a set of consecutive unoccupied blocks corresponding to the type of item for which the reservation is requested and covering the entire time period available for reservations are designated as fixed location blocks, the blocks corresponding to the reservation time period requested are designated as being occupied and the remaining designated fixed location blocks may not be combined with blocks other than the said fixed location blocks to provide a reservation.

Thus, a further reservation may still be provided from unoccupied fixed location blocks but only if the entire reservation is available in the time consecutive fixed location blocks.

In some instances consecutive unoccupied blocks corresponding to the type of item for which the reservation is requested and covering the entire time period available for reservations may not be present. In this case the system preferably alerts a user to the fact that it is possible that not all the reservations will be honoured if the fixed location reservation is accepted.

In an alternative embodiment, overbooking due to the packing problem may be solved by providing the reservation system of the invention with means for handling a fixed location reservation comprising means for checking whether any other fixed location reservations for items of the type requested have been made when a fixed location reservation is requested, means for selecting consecutive unoccupied blocks corresponding to the type of item for which the reservation is requested and covering the entire time period available for reservations, and means for designating the selected blocks corresponding to the reservation time period requested as being occupied, wherein if no other fixed location reservations for items of the type requested have been made, the selected blocks which precede the reservation time period are designated as fixed location blocks which may not be combined with other blocks corresponding to other items and the selected blocks coming after the reservation time period are retained in the data base as fungible or combinable blocks.

Still more preferably, where the system determines that other fixed location reservations for items of the type requested have been made, the system comprises means for identifying the latest block in time to have been designated as a fixed location block such that the selected blocks which precede the latest block to be designated as a fixed location block are designated as fixed location blocks which may not be combined with other blocks corresponding to other items and the selected blocks coming after the last block to be designated as a fixed location block are retained in the system as fungible or combinable blocks.

In a further alternative embodiment, overbooking due to the packing problem may be solved by providing the reservation system of the invention with means for handling a fixed location reservation comprising means for checking whether any other fixed location reservations for items of the type requested have been made when a fixed location reservation is requested, means for selecting consecutive unoccupied blocks corresponding to the type of item for which the reservation is requested and covering the entire time period available for reservations, and means for designating the selected blocks corresponding to the reservation time period requested as being occupied, wherein if no other fixed location reservations for items of the type requested have been made, the selected blocks which precede the reservation time period and precede any buffer period which the service provider choses to add before the reservation period, are retained in the data base as fungible or combinable blocks, and the selected blocks coming after the reservation time period are designated as fixed location blocks which may not be combined with other blocks corresponding to other items.

Still more preferably, where the system determines that other fixed location reservations for items of the type requested have been made, the system comprises means for identifying the earliest block in time to have been designated as a fixed location block such that the selected blocks which come after the earliest block to be designated as a fixed location block are designated as fixed location blocks which may not be combined with other blocks corresponding to other items and the selected blocks coming before the earliest block to be designated as a fixed location block are retained in the system as fungible or combinable blocks.

In a further alternative embodiment, the two previously described embodiments for handling fixed location reservations are combined. Thus, the system preferably designates the blocks required for the reservation as taken in fixed space, and designates the blocks which come after the earliest block to be designated as a fixed location block and the blocks which precede the latest block to be designated as a fixed location block as fixed location blocks which may not be combined with other blocks corresponding to other items. Any remaining blocks from the column of blocks relating to the item in question are retained as fungible or combinable blocks.

In the most preferred embodiment of the invention, the reservation system includes means for maximising the number of fungible or combinable blocks available within the system at any time by choosing the most effective combination of the alternative means of dealing with fixed location reservations as set out above.

Thus, the reservation system preferably further comprises: means for handling a fixed location reservation comprising means for checking whether any other fixed location reservations for items of the type requested have been made when a fixed location reservation is requested; means for selecting consecutive unoccupied blocks corresponding to the type of item for which the reservation is requested and covering the entire time period available for reservations; means for designating the selected blocks corresponding to the reservation time period requested as being occupied; means for identifying the latest block in time to have been designated as a fixed location block across all reservations made if not treated under way (iv); means for identifying the earliest block in time to have been designated as a fixed location block across all reservations made if not treated under way (iv); and means for treating each of the separate fixed location reservations in any one of the following ways in order to maximise the number of fungible or combinable blocks available within the database at any time:

i) designating the selected blocks which precede the latest block as fixed location blocks which may not be combined with other blocks to form a reservation and designating the selected blocks coming after the last block as fungible or combinable blocks; or

ii) designating the selected blocks which come after the earliest block to be designated as a fixed location block as fixed location blocks which may not be combined with other blocks to form a reservation and designating the selected blocks coming before the earliest block to be designated as a fixed location block as fungible or combinable blocks which are retained; or

iii) designating the blocks which come between the earliest block and the latest block as fixed location blocks which may not be combined with other blocks to form a reservation, and designating any remaining blocks from the selected blocks as fungible or combinable blocks which are retained; or

iv) designating all the selected blocks as fixed location blocks which may not be combined with other blocks to form a reservation,

wherein the way in which each separate fixed location reservation is treated may be altered each time that a new reservation is made, and the latest block and earliest block are re-identified each time that a new reservation is made or that the way in which any fixed location reservation is treated is altered.

In some cases, two or more non-overlapping fixed location reservations may be required for the same table in a session. In this instance, to maximise the free space retained in the reservation system, the two or more bookings may initially be treated as a single booking extending from the beginning of the first reservation until the end of the final reservation for that table. The blocks within the reservation system may then be treated by any of the alternative methods of handling fixed location reservations set out above such that at least some of the blocks coming before the first reservation or after the last reservation will be retained as fungible blocks which can be combined with other blocks to make a reservation. In addition however, any blocks coming between the various fixed location reservations for the table are designated as fixed location blocks. This means that these blocks may not be combined with blocks other than the fixed location blocks to form a reservation.

In order to further maximise the number of fungible or combinable blocks available within the system at any time, the system includes means to split the dining session into two separate sessions such that, if at any time every block representing a reservation has been reserved, the session may be split into a session up to and/or including that time and a session including and/or from after that time.

The features of the invention according to the second aspect thereof are equally applicable to a reservation system according to the first aspect of the invention in which available reservations are split between an individual service provider and a central reservation provider.

Thus, according to a further preferred aspect of the invention, blocks or sets of blocks of predetermined duration representing items available for reservation are distributed between the central reservation provider and the individual service provider. Other than in the case of fixed location reservations as discussed above, one or more blocks may be transferred between the central reservation provider and the individual service provider as required to allow reservations to be made. However, it will be understood that any blocks designated as fixed location blocks may not be transferred from the individual service provider to the central reservation provider.

In the case of fixed location reservations where the reservation system includes a central reservation provider and one or more individual service providers, the system is preferably configured such that fixed location reservations may only be made through the individual service provider, and the system includes means for determining whether blocks which are not available from the individual service provider from which the reservation has been requested are available from the central reservation provider, and means for transferring the blocks required from the central reservation provider to the individual service provider if they are available so as to provide the complete set of consecutive unoccupied blocks corresponding to the type of item for which the reservation is requested and covering the entire time period available for reservations as required. The complete set of blocks can then be dealt with as described in the alternative embodiments described above.

If the blocks required are not available from any of the central reservation provider or the individual service providers, then the system preferably alerts a user to the fact that it is possible that not all the reservations will be honoured if the fixed location reservation is accepted.

The invention also extends to computer programs for implementing the systems described above.

### BRIEF DESCRIPTION OF THE DRAWINGS

Preferred embodiments of the invention will now be described by way of example only and with reference to the accompanying drawings in which:

FIG. 1 schematically shows the arrangement between a central reservation provider and four individual service providers according to the invention;

FIG. 2 schematically shows the manner in which restaurant space is divided in restaurant reservation software according to a first embodiment of the invention;

FIG. 3 schematically shows the manner in which restaurant apace is divided in restaurant reservation software according to a first embodiment of the invention after one reservation in free space has been made;

FIG. 4 schematically shows the manner in which restaurant space is divided in restaurant reservation software according to a first embodiment of the invention after two reservations in free space have been made;

FIG. 5 schematically shows the manner in which restaurant space is divided in restaurant reservation software according to a first embodiment of the invention after several reservations in free space have been made;

FIG. 6 schematically shows the manner in which restaurant space is divided in restaurant reservation software according to a second embodiment of the invention after one reservation in fixed space has been made;

FIG. 7 schematically shows the manner in which restaurant space is divided in restaurant reservation software according to the second embodiment of the invention after reservations in free space and in fixed space have been made;

FIG. 8 schematically shows the manner in which restaurant space is divided in restaurant reservation software according to a third embodiment of the invention after one reservation in fixed space has been made;

FIG. 9 schematically shows the manner in which restaurant space is divided in restaurant reservation software according to the third embodiment of the invention after reservations in free and in fixed space have been made;

FIG. 10 schematically shows the manner in which restaurant space is divided in restaurant reservation software according to a fourth embodiment of the invention after one reservation in fixed space has been made;

FIGS. 11 to 17 show the display screen of restaurant reservation software according to the fourth embodiment of the invention in various alternative configurations after three reservations in fixed space have been made and show how the availability of free space within the system may be maximised; and

FIG. 18 schematically shows the manner in which restaurant space is divided in restaurant reservation software according to a fifth embodiment of the invention after reservations in free and fixed space have been made and shows the allocation of free space to the Internet reservation provider.

### DESCRIPTION OF THE BEST MODES OF THE INVENTION

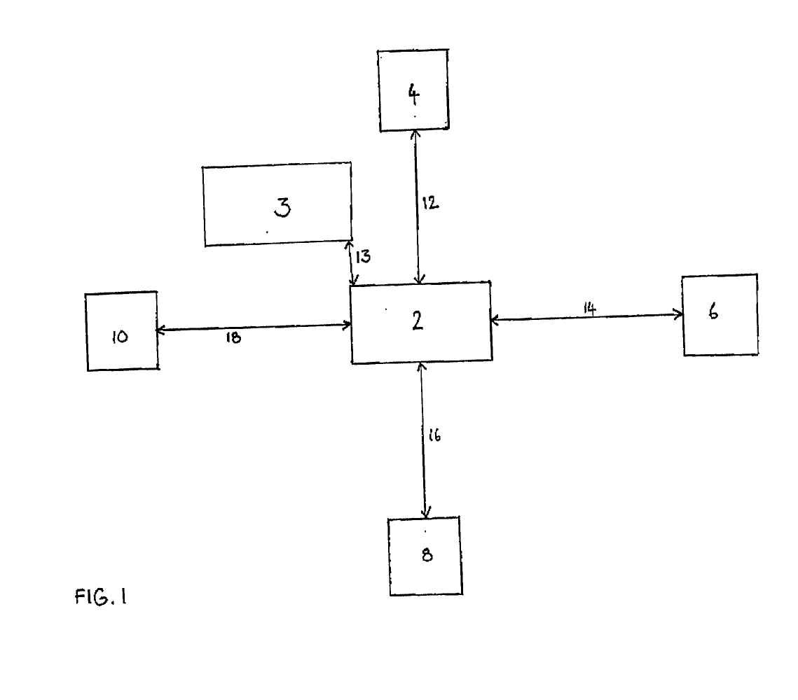

In the best mode thereof, the invention is implemented as an Internet restaurant reservation service through which restaurant tables may be booked either over the Internet or directly through the restaurant. FIG. 1 shows schematically the arrangement between the Internet reservation service and individual restaurants or service providers. As shown, a central Internet reservation service 2 can communicate with each of a number of individual restaurants 4, 6, 8 and 10. Each individual restaurant 4, 6, 8, 10 is provided with reservation software which is linked to the Internet reservation service via an Internet Service Provider (ISP) or a direct or dedicated line. As shown by arrows 12, 14, 16, 18, information may be transferred in both directions between the Internet reservation service and an individual restaurant when the Internet reservation service and restaurant are in communication. As shown, a second Internet reservation service 3 can also be provided which communicates directly with the first Internet reservation service 2 as shown by the arrow 13, and not with the individual restaurants.

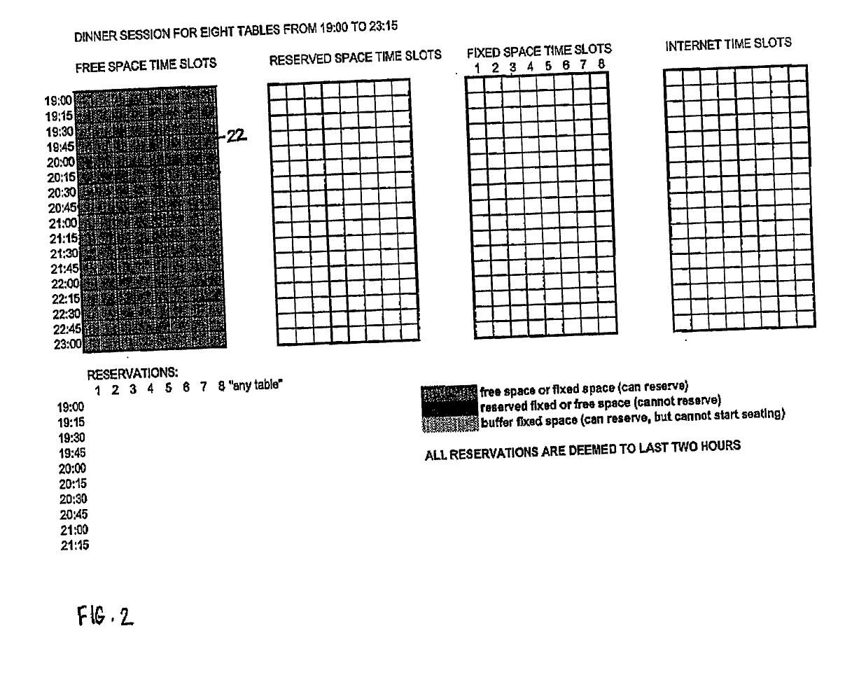

FIG. 2 schematically shows a database produced by restaurant 4 for a dinner session running from 19:00 to 23:15 for tables for 2 people. In the reservations database the restaurant is split into a group of virtual sections, each section containing only tables of one size. Thus, in a restaurant containing tables for 2, 3, 4, 5 and 6, the restaurant reservations will be dealt with in five separate virtual sections, one for each respective table size. As tables of different sizes are dealt with separately, only the allocation of tables for 2 are shown in this schematic representation.

The restaurant contains a total of 8 tables for 2 people and these tables are numbered from 1 to 8. The availability of each table over the dinner session is represented as a total of seventeen blocks of 15 minute time intervals, i.e. 15 minute time intervals covering the whole duration of the dinner session. Thus, in the example shown in the Figures, the database includes a total of 136 blocks. In order to distinguish between tables of different sizes to avoid mixing of the virtual sections, each block is tagged to indicate the table size to which it relates. Each block is also given a tag indicating the starting time of the 15 minute time interval (e.g. 19:45 in the case of block 22 in FIG. 2) and is designated as being either full or empty.

Before any reservations have been made, all of the blocks in the database are available and this is shown by the shading in the “free space time slots” grid of FIG. 2. Any blocks which are arranged consecutively one after the other in time may be joined together to form a table reservation, i.e. the blocks are fungible and whichever consecutive blocks of the same size are joined together it will always be possible to seat diners at the same table for the duration of their meal without overbooking the restaurant. Thus, there is no need for reservations to be made for a particular table unless specifically requested by a customer as will be described below. Consequently, all of the blocks are initially designated as “free space time slots”.

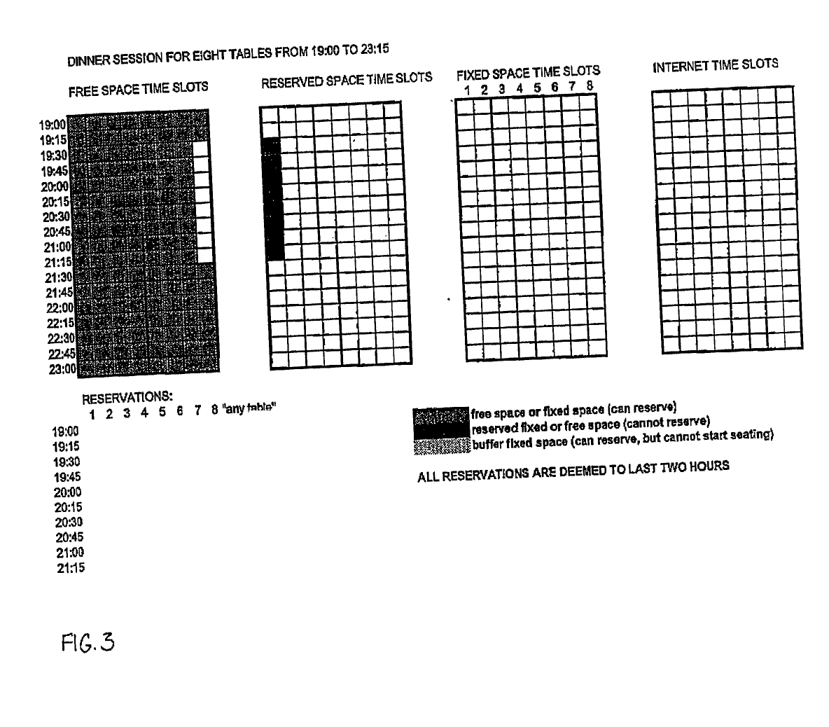

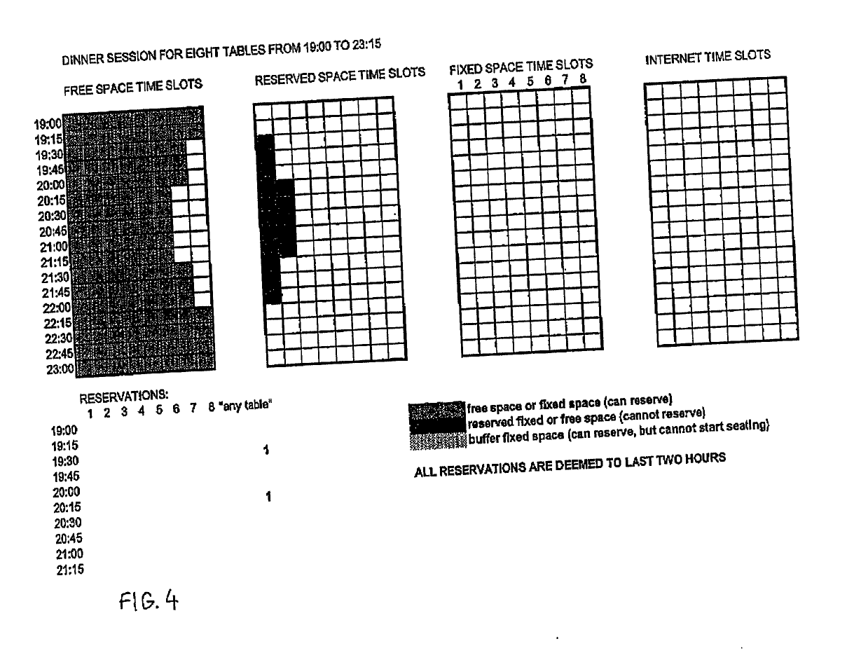

A customer may telephone the restaurant directly to make a reservation. In that case, the restaurant staff enter the reservation into their database. In the case shown in FIG. 3, the customer has reserved a table for 2 people from 19:30 to 21:30 but does not have any specific requirements. Thus, the database designates a total of eight consecutive time slots covering the relevant time period as being reserved and this is shown by the shading in the “reserved space time slots” grid of FIG. 3. Reservations will continue to be accepted by the restaurant as long as their database has consecutive time slots for the right size of table covering the required time span available. FIG. 4 shows the blocks which will be designated as reserved when a second reservation for any table for 2 is made for dinner from 20:15 to 22:15. As can be seen, the time slots from 21:30 until 22:15 are taken from the first column. However, the earlier time slots required for the second booking had already been used in the first column by the first booking and so these are taken from the second column. By using the fungible blocks of time in this way rather than designating when a particular table will be occupied, greater potential is provided for fitting extra reservations into the dinner session.

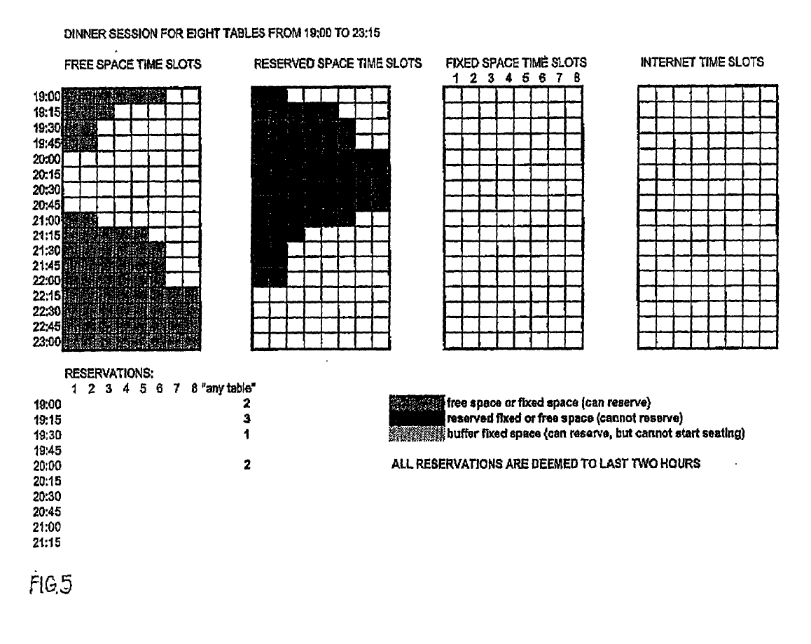

FIG. 5 shows a possible situation where several bookings have been made with the restaurant and none of these require any specific seating arrangement. The reserved blocks are shown in the “reserved space time slots” grid and from the “free space time slots” grid it can be seen that it would still be possible to seat several further tables starting from either 21:00 or 21:15.

Because the blocks of available time are fungible as described above, one or more series of time-contiguous blocks of 15 minute availability time intervals can be allocated to the central Internet reservation provider and there is no need for the central Internet reservation provider to be in constant communication with the restaurant database to avoid overbooking. Thus, ideally 10 or 20% of the available series of blocks from each restaurant database from restaurants 4, 6, 8 and 10 is provided to the central Internet reservation provider. One advantage of the fungible blocks of time according to the invention is that these can be traded as many times as required without any risk of overbooking the restaurant. Thus, if necessary, the fungible blocks could be distributed between a number of different Internet reservation providers and booking agencies. Consequently, the “free space” fungible blocks could be distributed between the restaurant and an “upseller”. This “upseller” need not be the final reservation maker but rather could provide its share of the blocks to one or more reservation providers. The “free space” blocks may be transferred between any and each of the “upseller”, the reservation providers and the restaurant as and when required.

When a customer wishes to make a reservation via the Internet they log onto the central Internet reservation provider and reserve a table for the restaurant of their choice in the same way as they would do directly via the restaurant. It is also possible for the central Internet reservation provider to conduct a search to find an available table at one of a number of restaurants if the user is having difficulty reserving the restaurant of their choice.

In some cases, time contiguous blocks covering the duration of the reservation required by the customer may no longer be available from within the free space time slots held by the central Internet reservation provider. In that case, the central Internet reservation provider contacts the restaurant database via an ISP or a direct or dedicated line and, if the free space is still available from the restaurant database, it is transferred to the central Internet reservation provider so that the reservation can be made. Conversely, additional free apace can be requested from the central Internet reservation provider by the restaurant should it be required. The restaurant reservation software is provided with means for automatically contacting the central Internet reservation provider when additional time blocks are required and ideally, this is activated by a restaurant staff member touching an icon (not shown) on a screen displaying the reservation information.

This method of requesting additional space only once there is none left has the disadvantage however that a customer would have to wait while a connection was formed and the relevant information was transferred between the reservation providers before being told whether or not his reservation had been accepted. Consequently, in an improved system, both the Internet reservation provider and the restaurant software are programmed to request space from other providers if the available space which they are holding drops below a predefined minimum level at any time. This means that it is less likely that a customer requesting a reservation will have to wait while contact is established between the restaurant and the Internet.

In addition to the above, the restaurant reservation software is configured to automatically establish contact between the central Internet reservation provider and the restaurant reservation database at regular intervals so as to update its records of the total number of reservations and to redistribute available free time blocks if necessary.

In certain circumstances, the blocks of time defined within the restaurant database cannot all be treated as being entirely fungible, i.e. they cannot be assumed to be free space time slots. In particular, problems with packing the restaurant arise where a customer requests to be seated at a specific table, where two or more tables are joined together to accommodate a larger party, or where tables have already been seated. These types of reservations are referred to as fixed table reservations. Various alternative ways of dealing with fixed table reservations are provided by the invention, each of which is described below. The following are definitions of terms used in the description of the alternative algorithms for dealing with fixed table reservations.

The following situations are recognised as constituting table allocation events requiring fixed table reservations by the system of the invention:

1. Table Allocation Event

A Table Allocation Event occurs when a particular table is assigned to a reservation for any fixed period of time. This could be

(i) a “Do Not Move”, whereby a particular customer has requested a particular table for his or her reservation,

(ii) a “Table joining” event, in which a large party shall be sitting on two tables of which one is the table in question,

(iii) a “Seating” event, whereby a customer walking into the restaurant has been seated on a table, i.e. the table has not been allocated by the reservation system but is none the less taken,

(iv) a “Blocking” event, whereby a particular table has been blocked from being seated for a particular period of time.

2. Latest Same-Size Allocated Time Slot.

Within a session (Breakfast, Lunch, Dinner, Late Dinner etc.) the Latest Same-Size Allocated Time Slot is the latest N-minute time slot for which any table of a particular size is subject to an Allocation Event.

For instance, if Table 1 is a table for 2 and is reserved from 7 until 9 pm and Table 3 is a table for 2 and is reserved from 8:30 until 10:30 pm and no other tales for 2 are reserved and the N-minute time slot is defined as a 15 minute time slot, then the Latest Same-Size Allocated Time Slot for tables for 2 is the Time Slot that starts at 10:15 and ends at 10:30.

3. Buffer

If a table is subject to an allocation event for a particular time period starting at time T, and assuming the longest a table of that size could ever be occupied for is X hours, then the Buffer is defined as the time period from time T-X until time T.

The logic behind the buffer is that if a particular table is to be occupied by a particular party starting at a particular time, that table should not be allocated to another reservation that starts at a time during the buffer, or there is a chance that the two reservations will clash. Thus, any blocks which are designated as being buffer within the reservation system may be reserved but only for a reservation which does not begin within the buffer space or for a reservation beginning within the buffer space but which is short enough to terminate before the end of the buffer period.

4. Earliest Same-Size Allocated Time Slot

Within a session (breakfast, Lunch, Dinner, Late Dinner etc.) the Earliest Same-Size Allocated Time Slot is the earliest N-minute time slot that is part of the Buffer which precedes an Allocation Event.

For instance, if Table 1 is a table for 2 and is reserved from 7 pm onwards and Table 3 is a table for 2 and is reserved from 8:30 pm onwards and no other tables for 2 are reserved and the an N-minute time slot is defined as a 15 minute time slot, and the longest a table for 2 could ever be sat for is 3 hours, then the Earliest Same-Size Allocated Time Slot for tables for 2 is the time Slot that starts at 4 pm and ends at 4:15 pm. This is because the buffer on table 2 starts at 4 pm and ends at 7 pm.

The following identifies six alternative algorithms which may be used within the reservation system according to the invention to allow fixed table reservations to be handled effectively. The most preferred algorithm is algorithm number 6 as this will be the most efficient in packing as many reservations as possible into the restaurant without overbooking it.

### ALGORITHM 1

Subsequent to a table allocation event, the following actions take place:

1. The availability of space (N-minute time slots) for the table is removed from “Free Space” for the entire session.

2. The availability of space (N-minute time slots) for the table is added to “Fixed Space” for the entire dining session.

3. Within “Fixed Space”, the availability of space (N-minute time slots) for the table during the time of the allocation event is marked as “Reserved”.

Then “Free Space” remains tradable with other databases, “Fixed Space” that is not marked as “Reserved” cannot be combined with “free space” and “Fixed Space” that is marked as “Reserved” cannot be allocated to new reservations, or a double booking would occur.

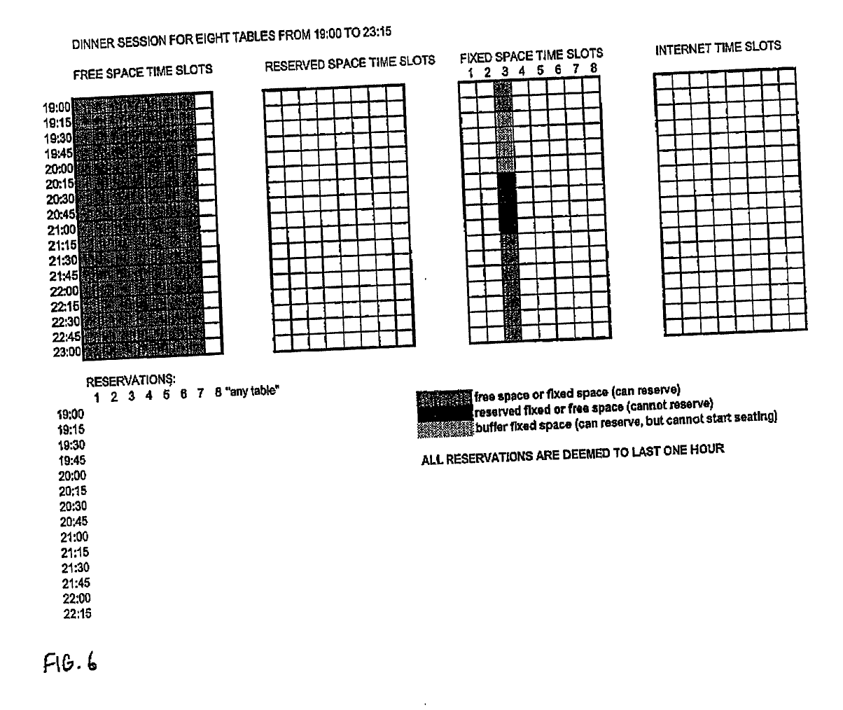

FIG. 6 schematically shows the division of restaurant space when a single one hour fixed space booking from 20:30 until 21:30 has been made using algorithm 1. As shown, an entire column of blocks has been designated as “fixed space time slots”. Within this column, the blocks representing the reservation have been marked as being reserved, the four blocks in the hour preceding the reservation have been marked as buffers, and the remaining time slots are available to be reserved but are in the fixed space grid which means that they cannot be combined with other time slots from other columns.

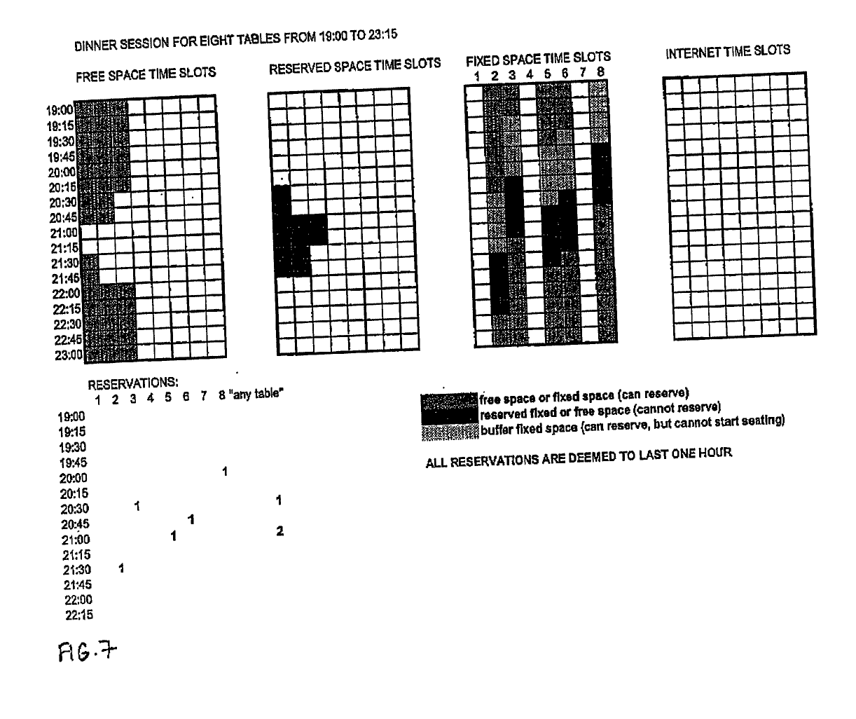

FIG. 7 then shows the division of restaurant space in the restaurant software at a later stage when a total of 5 fixed location reservations for tables 2, 3, 5, 6 and 8 at 21:45, 20:30, 21:00, 20:45 and 20:00 respectively have been made. As shown, five full columns of the time slots have been moved from the free space grid to the fixed space grid. Non-fixed location reservations have also been made for one table at 20:30 and two tables at 21:00 and these reservations are shown in the reserved space time slots grid. The blocks designated as “fixed space” can no longer be combined with fungible “free space” blocks or indeed with “fixed space” blocks from other columns. Thus, in the situation shown in FIG. 7, the restaurant could reserve table 8 for a second customer from 22:00 to 23:00.

### ALGORITHM 2

1. The availability of space (N-minute time slots) for the table during the time of the allocation event is removed from “Free Space” and added to “Fixed Space” and marked as “Reserved”.

2. The availability of space (N-minute time slots) for the table from the end of the Allocation Event up to and including the Latest Same-Size Allocated Time Slot is removed from “Free Space” and added to “Fixed Space”

3. The availability of space (N-minute time slots) prior to the Allocation Event is removed from “Free Space” and is added to “Fixed Space”

Crucially, all space (N-minute time slots) after the Latest Same-Size Allocated Time Slot until the end of the session remains in Free Space. In other words, all space after the last N-minute slot of the latest reservation stays in “Free Space”.

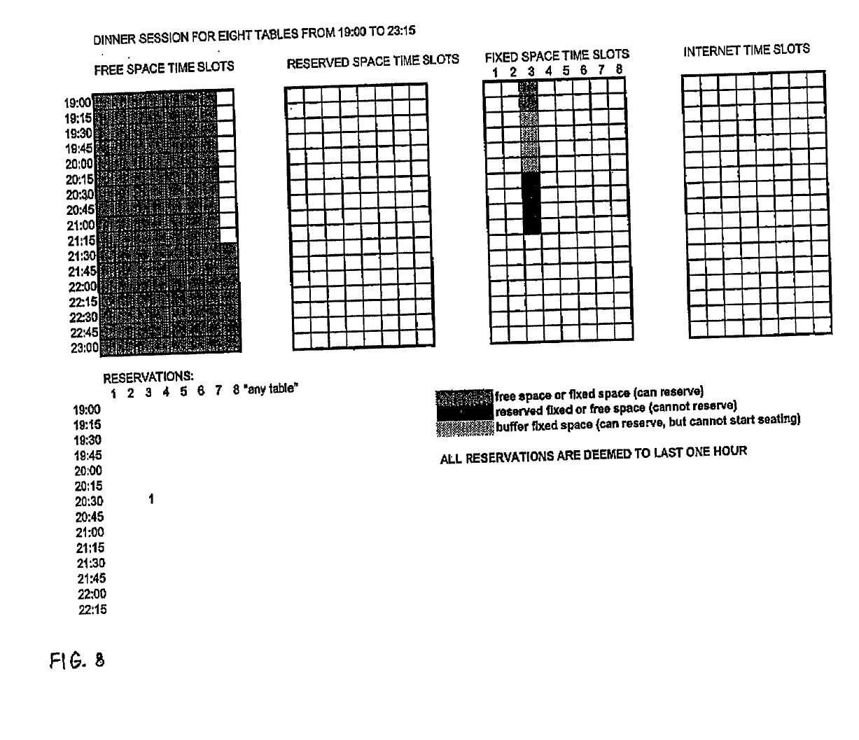

FIG. 8 schematically shows the manner in which restaurant space is divided when only a single fixed location reservation has been made using this algorithm. As shown the reservation is for one hour from 20:30. Thus, the time slots from 21:30 onwards remain in free space. A one hour buffer is included in the fixed space grid before the reservation as for algorithm 1.

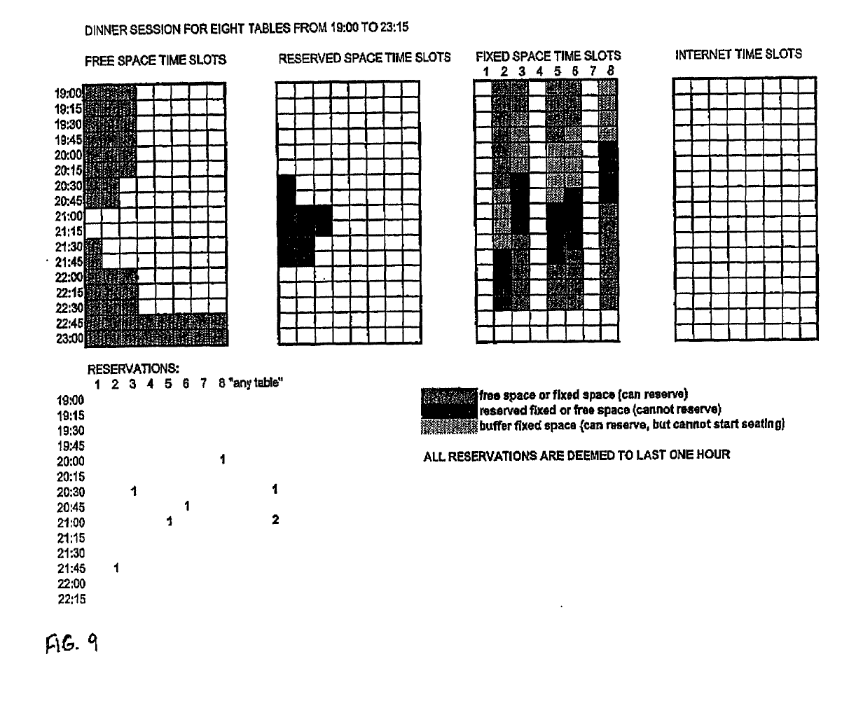

FIG. 9 shows the situation when a total of five fixed location reservations have been made. The latest of these reservations runs until 22:45 and so all the time slots in fixed space columns up until this time are retained in the fixed space grid but none of the time slots beyond that time are held in fixed space. As shown in the reserved space time slot grid, three non-fixed location reservations have been made, one for 20:30 and two for 21:00.

### ALGORITHM 3

1. The availability of space (N-minute time slots) for the table during the time of the allocation event is removed from “Free Space” and added to “Fixed Space” and marked as “Reserved”.

2. The availability of space (N-minute time slots) for the table from the Earliest Same-Size Allocated Time Slot until the beginning of the Allocation Event is removed from “Free Space” and added to “Fixed Space”

3. The availability of space (N-minute time slots) subsequent to the Allocation Event is removed from “Free Space” and is added to “Fixed Space”

Crucially, all space (N-minute time slots) from the beginning of the session until the Earliest Same-Size Allocated Time Slot remains in Free Space. In other words, all space prior to the first N-minute slot of the earliest Buffer stays in “Free Space”.

### ALGORITHM 4

1. The availability of space (N-minute time slots) for the table during the time of the allocation event is removed from “Free Space” and added to “Fixed Space” and marked as “Reserved”.

2. The availability of space (N-minute time slots) for the table from the Earliest Same-Size Allocated Time Slot until the beginning of the Allocation Event is removed from “Free Space” and added to “Fixed Space”

3. The availability of space (N-minute time slots) for the table from the end of the Allocation Event up to and including the Latest Same-Size Allocated Time Slot is removed from “Free Space” and added to “Fixed Space”

Crucially, all space (N-minute time slots) from the beginning of the session until the Earliest Same-Size Allocated Time Slot AND all space (N-minute time slots) after the Latest Same-Size Allocated Time Slot until the end of the session remains in Free Space. In other words, all space prior to the first N-minute slot of the earliest Buffer AND all space after the last N-minute slot of the latest reservation stays in “Free Space”.

### ALGORITHM 5

It is possible to maximise the amount of free space by applying algorithm 1 to some tables and algorithm 4 to other tables.

For every table that has been subject to an allocation event, a decision needs to be made: The first choice is that it can be treated as a “safe” table. If it is treated as a “safe” table, then

1. The availability of space (N-minute time slots) for the table is removed from “Free Space” for the entire session.

2. The availability of space (N-minute time slots) for the table is added to “Fixed Space” for the entire dining session.

3. Within “Fixed Space”, the availability of space (N-minute time slots) for the table during the time of the allocation event is marked as “Reserved”

4. The Latest Same-Size Allocated Time Slot is REDEFINED AS the latest N-minute time slot for which any table of a particular size EXCEPT FOR THIS TABLE is subject to an Allocation Event.

5. The Earliest Same-Size Allocated Time Slot is REDEFINED AS the earliest N-minute time slot that is part of the Buffer which precedes an Allocation Event FOR ANY TABLE EXCEPT FOR THIS TABLE .

Alternatively, it can be treated exactly like in Algorithm 2, Algorithm 3 or Algorithm 4 SUBJECT TO THE CHANGES TO THE DEFINITIONS OF THE LATEST AND EARLIEST SAME-SIZE ALLOCATED TIME SLOT THAT MAY HAVE RESULTED FROM OTHER TABLES HAVING BEEN TREATED AS “SAFE” TABLES.

This can be dynamically revised during the process. So if a restaurant's tables are fully allocated for 18:00 to 21:00 and not allocated at all from 21:00 onwards, an allocation event for a single table at 21:00 does not result in the edges of all tables being cut. Instead, a single table is taken out of free space for the whole night and the remaining tables all retain their edges.

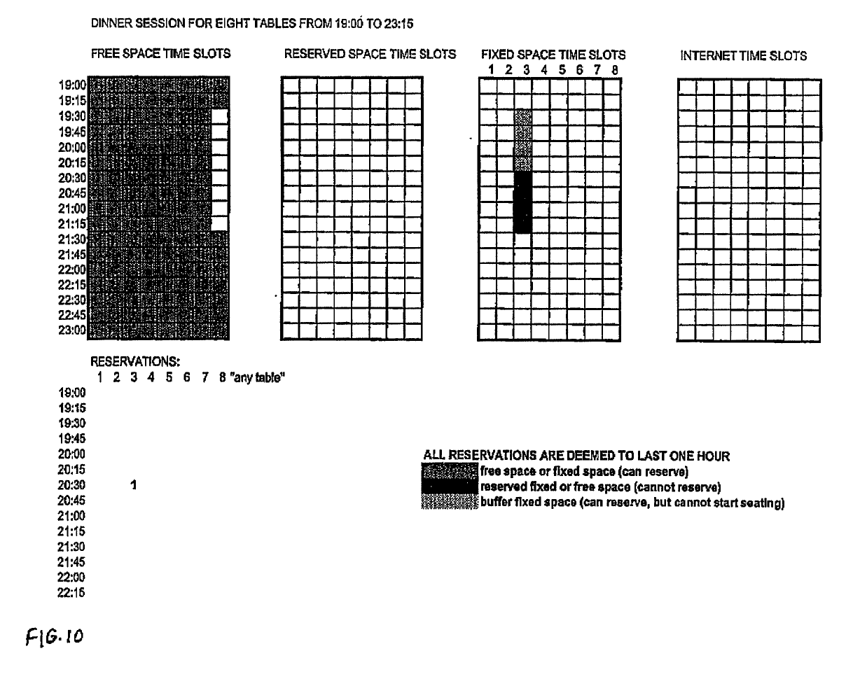

FIG. 10 schematically shows the division of restaurant space by the restaurant software when only a single fixed location reservation for a table from 20:30 to 21:30 has been made. In this instance, the time slots prior to the one hour buffer and after the end of the reservation are retained as “free space”.

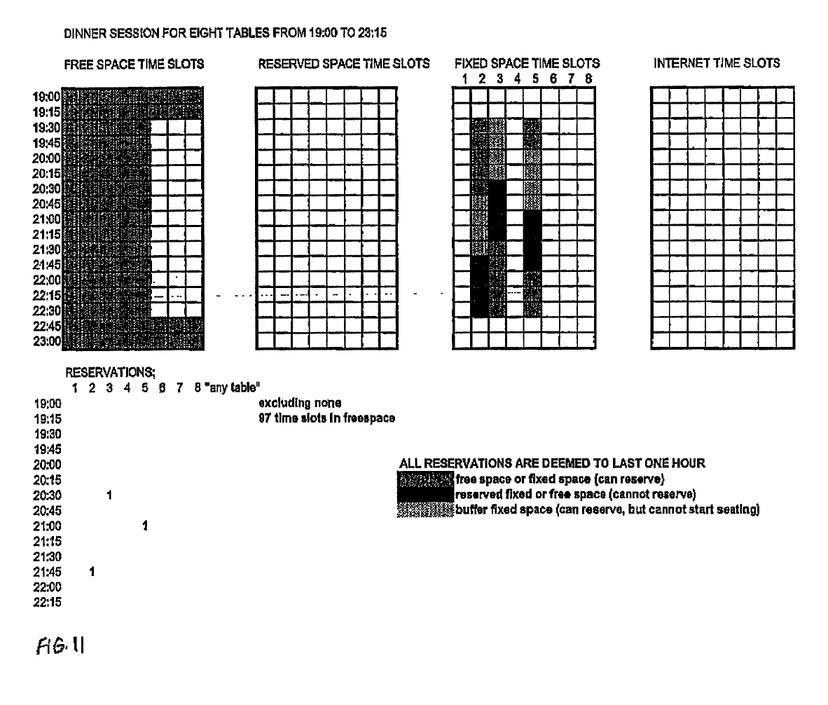

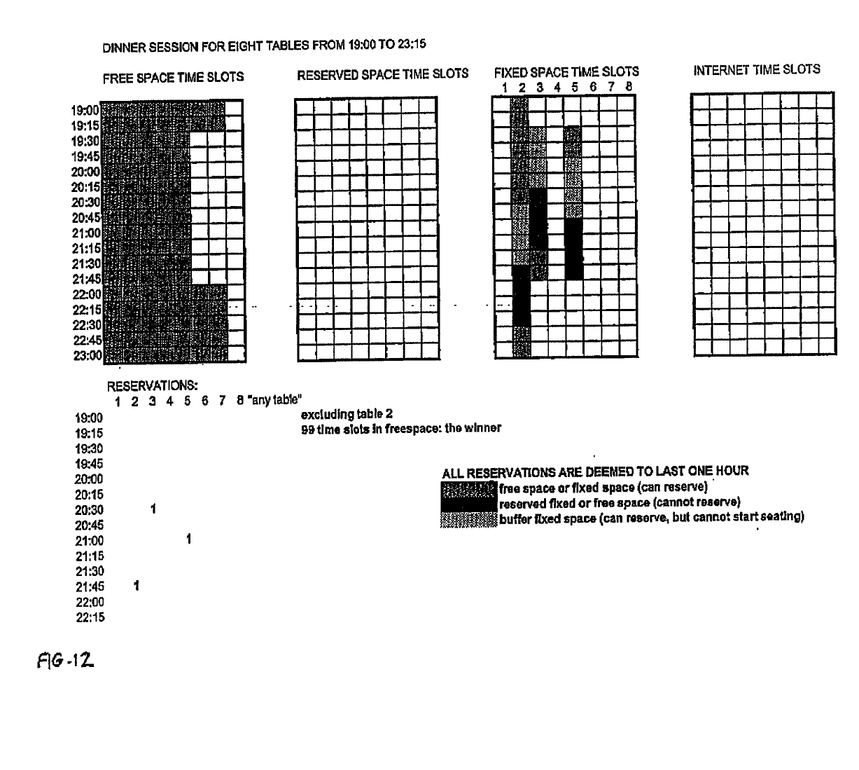

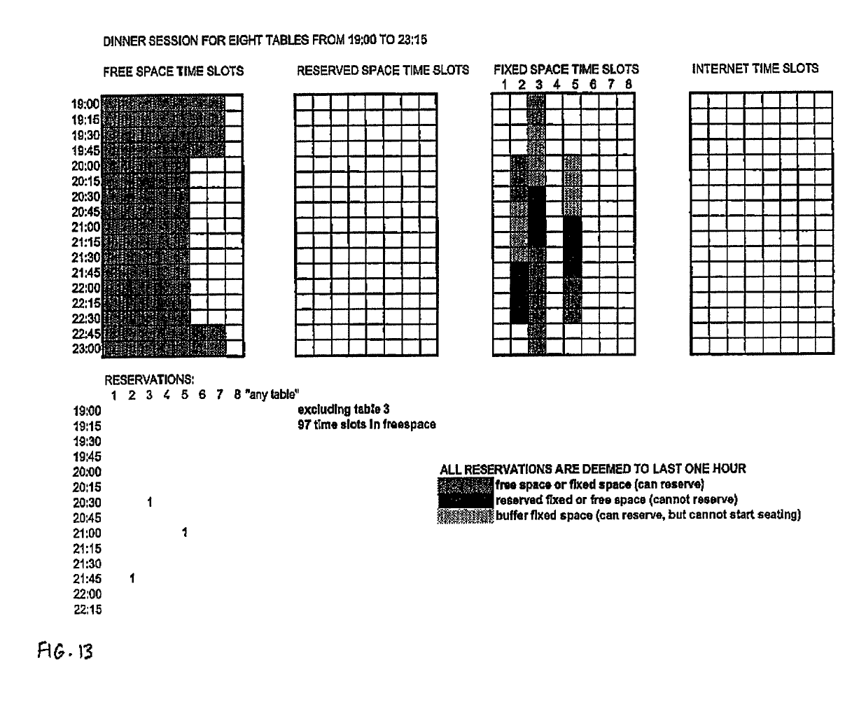

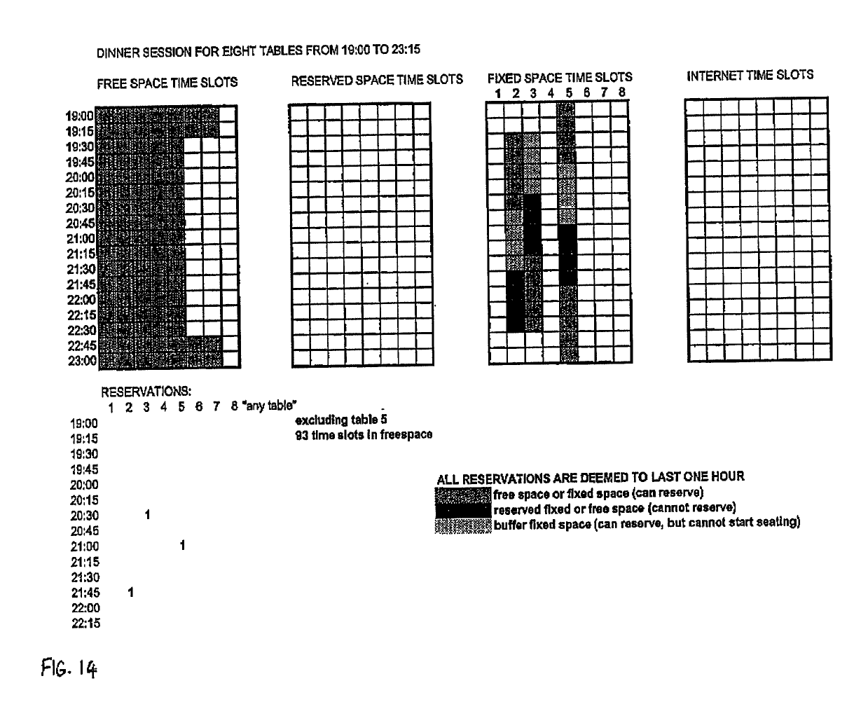

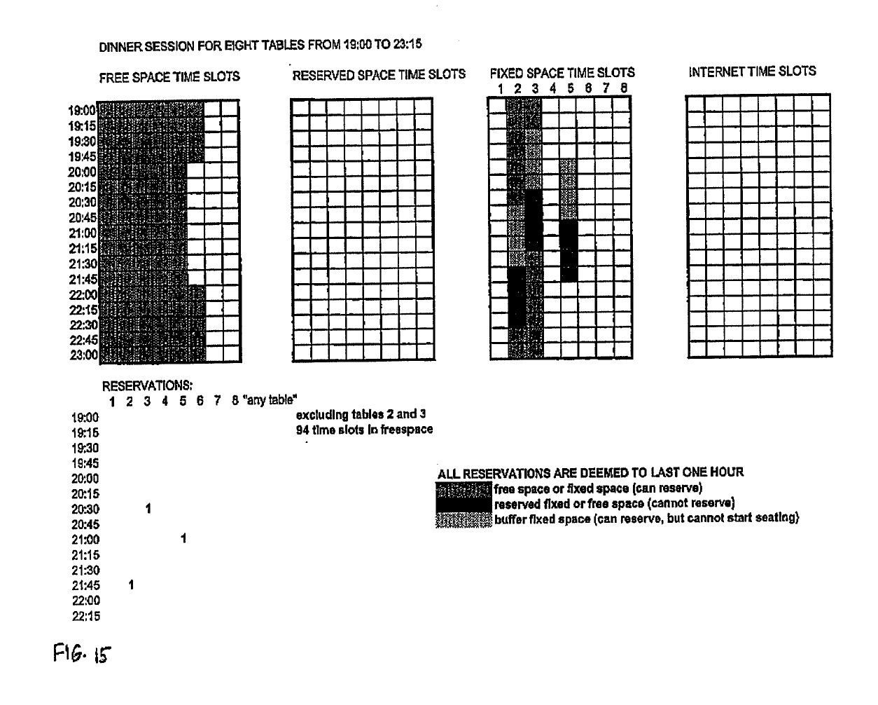

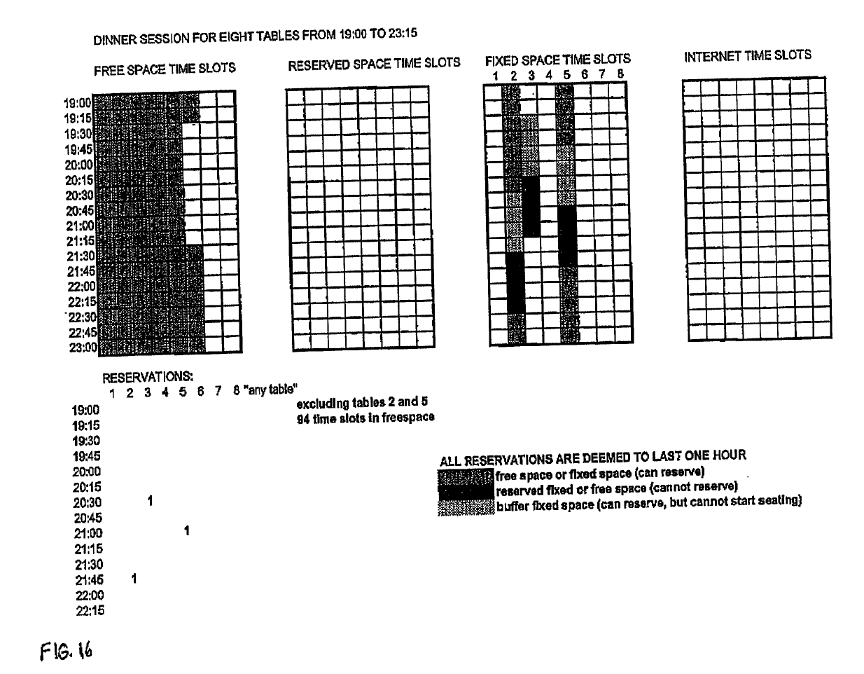

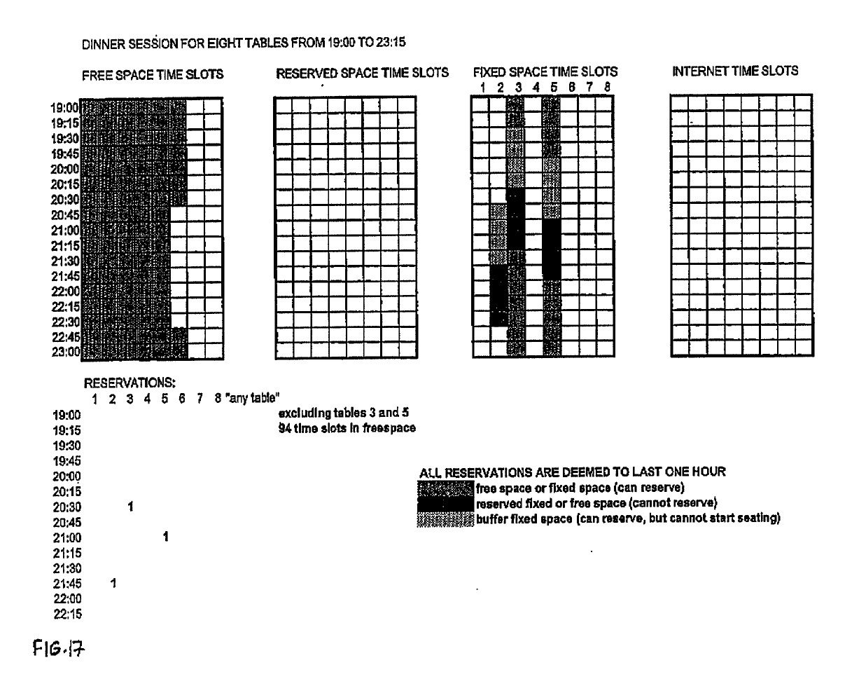

FIGS. 11 to 17 then show how the computer can use algorithm 5 for example to maximise the amount of free space retained by the booking system when three fixed table reservations at 21:45, 20:30 and 21:00 respectively have been made. As shown in the figures, the arrangement of FIG. 12 which retains 99 slots in free space provides the optimum arrangement and so the reservation system would adopt this arrangement. Alternatively, the algorithm could be used to optimise desired criteria other than the amount of free space available, for instance to maximise the amount of non-disjoint free space.

### ALGORITHM 6

If there is at least one N-minute time slot for which the number of reservations equals the number of tables, the dining session can be split into two “Disjoint” dining sessions: One up to the N-minute time slot for which the number of reservations equals the number of tables and one after. The N-minute time slot for which the number of reservations equals the number of tables can belong in either of the two “Disjoint” dining sessions without loss of generality.

In this event, all above algorithms can be applied separately to the first and the second “Disjoint” dining sessions.

In some cases, two or more non-overlapping fixed location reservations may be required for the same table in a session (for example fixed space reservations may be made for a table from 17:00 to 19:00 and from 22:00 to 00:00). In this instance, to maximise the free space retained in the reservation system, the two or more bookings are initially treated as a single booking from 17:00 to 00:00. The reservation is then treated by any of the alternative algorithms set out above such that at least some of the blocks coming before 17:00 or after 00:00 will be retained as fungible blocks which can be combined with other blocks to make a reservation. In addition however, any blocks coming between the various fixed location reservations for the table (i.e. the blocks from 19:00 to 22:00) are designated as fixed location blocks. This means that these blocks may not be combined with blocks other than the fixed location blocks to form a reservation. However, if a customer requested a reservation for the same table from 19:30 to 21:30, this reservation could be made as it is covered entirely by the fixed location blocks.

Under each of the algorithms described above, the resulting “Free Space” preserves the fundamental property of “Free Space”:

If consecutive N-minute time intervals exist in “Free Space” for a particular size of table there will always be a way to sit down diners in the restaurant on the same table for the entire duration of their meal. No packing problem or overbooking will arise if no diner has preferences for a particular table.

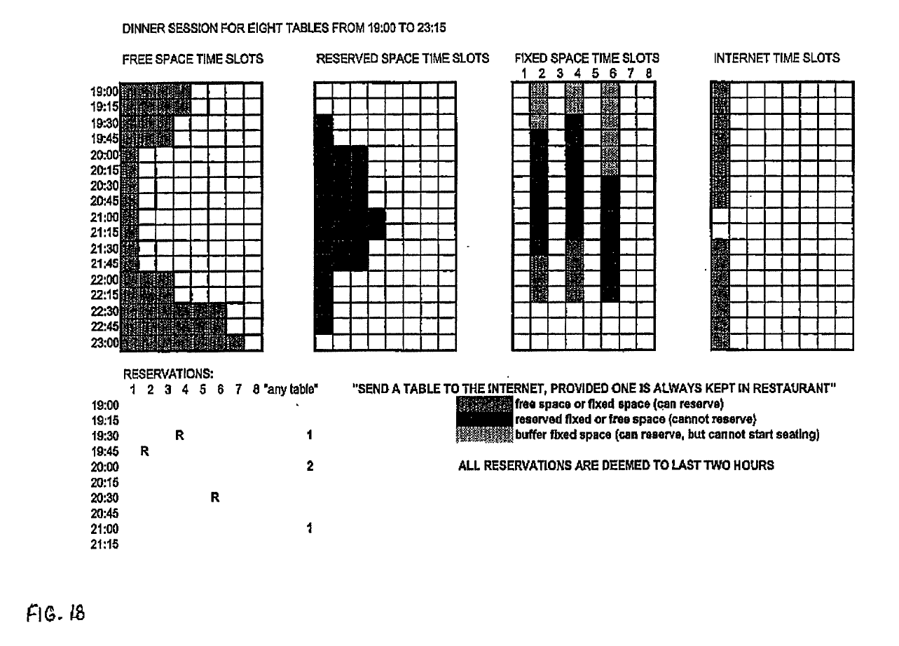

The possibility of providing some “free space” to the Internet reservation provider is discussed above. FIG. 18 schematically shows a system in which the restaurant software is programmed to allow the Internet reservation provider one table for bookings but on the condition that at least one spare table is always available in the restaurant. As shown in FIG. 18, various free and fixed space reservations have already been made directly with the restaurant. Consequently, only free space from 19:00 to 21;00 and from 21:30 to 23:15 is provided to the Internet as this allows a free table for the entire duration of the dinner session to be retained by the restaurant.

The invention has been described with reference to specific embodiments. It will be apparent to those skilled in the art that modifications may be made without departing from the spirit and scope of the invention as set forth in the appended claims.

What is claimed is:

1. A system for making customer reservations, the system comprising:
at least one individual service provider through which reservations for the respective individual service providers may be made directly;
a central reservation provider through which reservations for the at least one individual service provider may be made; and
means for communicating between the central reservation provider and the respective individual service providers, wherein a first portion of the available reservations from each individual service provider are held by the central reservation provider and a second portion of the available reservations from each individual service provider are held by each respective individual service provider and, if a reservation requested from either the central reservation provider or an individual service provider is not available from that provider, available reservations are transferred from the other of the central reservation provider or the individual service provider to the central reservation provider or the individual service provider via the means for communicating so as to allow a reservation to be made.

2. A reservation system as claimed in claim 1, wherein the central reservation provider is an Internet booking service.

3. A reservation system as claimed in claim 2, wherein the individual service provider uses computer software for communicating automatically with the Internet booking service.

4. A reservation system as claimed in claim 3, wherein the reservation system is installed over a local area network.

5. A reservation system as claimed in claim 1, wherein the system comprises means for automatically activating the means for communicating between the central reservation provider and individual service providers at regular intervals to transfer available reservations between the providers if the distribution of the available reservations between the providers is out of balance.

6. A reservation system as claimed in claim 1, the system further comprising means for reserving one of a plurality of items from available reservations, in which the time period of availability of each item is divided into consecutive blocks of a predetermined duration so as to provide a plurality of sets of said consecutive blocks representing the total availability of items within the time period, wherein the system accepts a reservation request if at least one consecutive block is available for each part of the time period for which the reservation is required such that blocks relating to more than one of the items may be combined to provide the reservation.

7. A reservation system for reserving one of a plurality of items, the system comprising means for dividing the time period of availability of each item into consecutive blocks of a predetermined duration so as to provide a plurality of sets of said consecutive blocks representing the total availability of items within the time period, wherein the system accepts a reservation request if at least one consecutive block is available for each part of the time period for which the reservation is required such that blocks relating to more than one of the items may be combined to provide the reservation.

8. A reservation system as claimed in claim 7, further comprising:
a database for storing data defining the numbers and types of items available for reservation together with details of any reservations made; and
means for calculating the number of available blocks using the data from the database each time that a reservation is requested.

9. A reservation system as claimed in claim 7, wherein the system is for reserving a plurality of different types of item and the blocks are tagged to indicate the type of item to which they refer.

10. A reservation system as claimed in claim 9, wherein a reservation is only made if at least one consecutive block relating to the type of item required is available for each consecutive part of the time period for which the reservation is required.

11. A reservation system as claimed in claim 7, wherein the system is for making restaurant reservations and the blocks are of 15 minute duration.

12. A reservation system as claimed in claim 7, wherein the system includes means for handling a fixed location reservation such that when a fixed location reservation is requested, a set of consecutive unoccupied blocks corresponding to the type of item for which the reservation is requested and covering the entire time period available for reservations are designated as fixed location blocks, the blocks corresponding to the reservation time period requested are designated as being occupied and the remaining designated fixed location blocks may not be combined with blocks other than the said fixed location blocks to form a reservation.

13. A reservation system as claimed in claim 12, wherein if consecutive unoccupied blocks corresponding to the type of item for which the reservation is requested and covering the entire time period available for reservations are not present, the system preferably alerts a user to the fact that it is possible that not all of the reservations made by the system will be honoured if the fixed location reservation is accepted.

14. A reservation system as claimed in claim 7, wherein the system includes:
means for handling a fixed location reservation comprising means for checking whether any other fixed location reservations for items of the type requested have been made when a fixed location reservation is requested;
means for selecting consecutive unoccupied blocks corresponding to the type of item for which the reservation is requested and covering the entire time period available for reservations; and
means for designating the selected blocks corresponding to the reservation time period requested as being occupied, wherein if no other fixed location reservations for items of the type requested have been made, the selected blocks which precede the reservation time period are designated as fixed location blocks which may not be combined with other blocks to form a reservation and the selected blocks coming after the reservation time period are retained as fungible or combinable blocks.

15. A reservation system as claimed in claim 14, wherein the system further comprises means for identifying the latest block in time to have been designated as a fixed location block, such that when the system determines that other fixed location reservations for items of the type requested have been made, the selected blocks which precede the latest block to be designated as a fixed location block are designated as fixed location blocks which may not be combined with other blocks to form a reservation and the selected blocks coming after the last block to be designated as a fixed location block are retained in the system as fungible or combinable blocks.

16. A reservation system as claimed in claim 7, wherein the system includes means for handling a fixed location reservation comprising:
means for checking whether any other fixed location reservations for items of the type requested have been made when a fixed location reservation is requested;
means for selecting consecutive unoccupied blocks corresponding to the type of item for which the reservation is requested and covering the entire time period available for reservations; and
means for designating the selected blocks corresponding to the reservation time period requested as being occupied, wherein if no other fixed location reservations for items of the type requested have been made, the selected blocks which precede the reservation time period and any buffer period which the service provider choses to add before the reservation period are retained as fungible or combinable blocks, and the selected blocks coming after the reservation time period are designated as fixed location blocks which may not be combined with other blocks to form a reservation.

17. A reservation system as claimed in claim 16, wherein the system further comprises means for identifying the earliest block in time to have been designated as a fixed location block, such that when the system determines that other fixed location reservations for items of the type requested have been made, the selected blocks which come after the earliest block to be designated as a fixed location block are designated as fixed location blocks which may not be combined with other blocks to form a reservation and the selected blocks coming before the earliest block to be designated as a fixed location block are retained in the system as fungible or combinable blocks.

18. A reservation system as claimed in claim 7, wherein the system includes:
means for handling a fixed location reservation comprising:
means for selecting consecutive unoccupied blocks corresponding to the type of item for which the reservation is requested and covering the entire time period available for reservations;
means for identifying the earliest block in time to have been designated as a fixed location block;
means for identifying the latest block in time to have been designated as a fixed location block; and
means for designating the selected blocks corresponding to the reservation time period requested as being occupied, wherein the system designates the blocks which come after the earliest block to be designated and the blocks which precede the latest block to be designated as fixed location blocks which may not be combined with other blocks to form a reservation, and wherein any remaining blocks from the selected blocks are retained as fungible or combinable blocks.

19. A reservation system as claimed in claim 7, further comprising:
means for handling a fixed location reservation comprising means for checking whether any other fixed location reservations for items of the type requested have been made when a fixed location reservation is requested;
means for selecting consecutive unoccupied blocks corresponding to the type of item for which the reservation is requested and covering the entire time period available for reservations;
means for designating the selected blocks corresponding to the reservation time period requested as being occupied;
means for identifying the latest block in time to have been designated as a fixed location block across all reservations made if not treated under way (iv);
means for identifying the earliest block in time to have been designated as a fixed location block across all reservations made if not treated under way (iv); and
means for treating each of the separate fixed location reservations in any one of the following ways in order to maximise the number of fungible or combinable blocks available within the database at any time:
i) designating the selected blocks which precede the latest block as fixed location blocks which may not be combined with other blocks to form a reservation and designating the selected blocks coming after the last block as fungible or combinable blocks; or
ii) designating the selected blocks which come after the earliest block to be designated as a fixed location block as fixed location blocks which may not be combined with other blocks to form a reservation and designating the selected blocks coming before the earliest block to be designated as a fixed location block as fungible or combinable blocks which are retained; or
iii) designating the blocks which come between the earliest block and the latest block as fixed location blocks which may not be combined with other blocks to form a reservation, and designating any remaining blocks from the selected blocks as fungible or combinable blocks which are retained; or
iv) designating all the selected blocks as fixed location blocks which may not be combined with other blocks to form a reservation,
wherein the way in which each separate fixed location reservation is treated may be altered each time that a new reservation is made, and the latest block and earliest block are re-identified each time that a new reservation is made or that the way in which any fixed location reservation is treated is altered.

20. A reservation system as claimed in claim 19, the system further comprising means for handling at least two fixed location reservations for the same item, in which the at least two reservations are treated as a single reservation in one of ways (i), (ii) and (iii), and any blocks located between the at least two reservations in time are designated as fixed location blocks which may not be combined with other blocks to form a reservation.

21. A reservation system as claimed in claim 19, the system further comprising means to split the dining session into two separate sessions such that, if at any time every block representing a reservation has been reserved, the session may be split into a first session up to and/or including that time and a second session including and/or from after that time in order to further maximise the number of fungible or combinable blocks available within the system at any time.

22. A reservation system as claimed in claim 7, wherein blocks or sets of blocks of predetermined duration representing items available for reservation from an individual service provider are distributed between a central reservation provider and the individual service provider such that reservations may be made through either of the individual service provider or the central reservation provider.

23. A reservation system as claimed in claim 22, the system further comprising means for communicating between the central reservation provider and the individual service provider, wherein if a reservation requested from either the central reservation provider or the individual service provider is not available from that provider, available blocks or sets of blocks are transferred from the other of the central reservation provider or the individual service provider to the central reservation provider or the individual service provider via the means for communicating so as to allow a reservation to be made.

24. A reservation system as claimed in claim 22, the system further comprising means for communicating between the central reservation provider and the individual service provider, wherein if the number of blocks or sets of blocks held by either the central reservation provider or the individual service provider falls below a predetermined minimum level at any time, available blocks are transferred from the other of the central reservation provider or the individual service provider to the central reservation provider or the individual service provider via the means for communicating.

25. A reservation system as claimed in claim 22, wherein the system is configured such that fixed location reservations may only be made through the individual service provider.

26. A reservation system as claimed in claim 25, wherein if the blocks required to make a fixed location reservation are not available from the central reservation provider or the individual service provider, the system alerts a user to the fact that it is possible that not all the reservations will be honoured if the fixed location reservation is accepted.
